(19) United States
(12) Patent Application Publication
(10) Pub. No.: US 2008/0127691 A1
(43) Pub. Date: Jun. 5, 2008

(54) ANTI-THEFT DEVICE

(76) Inventors: Thomas Castillo, Garden Grove, CA (US); Gloria Mason, Garden Grove, CA (US)

Correspondence Address: WOOD AND EISENBERG, PLLC, 6911 RICHMOND HIGHWAY, SUITE 403, Alexandria, VA, 22306, US

(21) Appl. No.: 11/948,919

(22) Filed: Nov. 30, 2007

Related U.S. Application Data
(60) Provisional application No. 60/868,087, filed on Nov. 30, 2006.

(51) Int. Cl. E05B 65/12

(52) U.S. Cl. 70/225

(57) ABSTRACT

An anti-theft device prevents illicit access to a wheel's hub area and more particularly to the wheel lug nuts. The anti-theft device includes a top faceplate overlying a lug nut bracket. In a preferred embodiment, the top faceplate is coextensive in outline with the underlying lug nut bracket. The top faceplate is detachably secured to the lug nut bracket by a locking device having a cylinder lock connected to a lock arm. The lock arm passes through an aperture in the lug nut bracket during assembly of the top faceplate with the lug nut bracket, but when rotated into a locking position the lock arm retains the lug nut member to the top faceplate. The cylinder lock is key operated, and with a correct key inserted it can be turned to permit removal of the top faceplate from the underlying lug nut bracket 140. Embodiments are shown for use with asymmetrically disposed lug nut members on axles having an odd number of nuts.

### CROSS REFERENCE TO RELATED APPLICATIONS

This application claims the benefit of priority from U.S. Provisional Patent Application Ser. No. 60/868,087, filed Nov. 30, 2006.

### STATEMENT REGARDING FEDERALLY SPONSORED RESEARCH OR DEVELOPMENT

Not applicable.

### FIELD OF THE INVENTION

The present invention relates generally to security locks to help prevent theft of vehicle wheels and rims including automobile wheels and rims.

### BACKGROUND OF THE INVENTION

Theft of car parts is a problem for vehicle owners and especially for owners who purchase and fit expensive trim to their vehicles. Custom wheels and tire rims are examples of items that are often stolen from vehicles such as pickup trucks and automobiles. Thus, there is a need to protect vehicle owners from the illegal removal of vehicle items such as tires, car wheels, and tire rims.

### SUMMARY OF THE INVENTION

From the foregoing, it is seen that it is a problem in the art to provide a device meeting the above requirements. According to the present invention, a device is provided which meets the aforementioned requirements and needs in the prior art. Specifically, the device according to the present invention provides an anti-theft device for securing tires, automobile wheels, and tire rims against theft.

The device according to the present invention includes a lug nut bracket for attachment to wheel lugs of a vehicle, and a top faceplate which is removably secured to the lug nut bracket by a locking device.

Other objects and advantages of the present invention will be more readily apparent from the following detailed description when read in conjunction with the accompanying drawings.

### BRIEF DESCRIPTION OF THE DRAWINGS

FIG. 1 is front elevational view of an anti-theft device according to the present invention, showing a top faceplate partially broken away to reveal an underlying lug nut bracket.

FIG. 2 is a schematic side sectional view taken along a centerline of the anti-theft device of FIG. 1, the section schematically showing lug nuts securing the lug nut bracket, and also showing a lock arm securing the lug nut bracket to the top faceplate.

FIG. 3 is a side elevational view of an embodiment of the lug nut bracket, showing a pair of male guides projecting from a surface of the lug nut bracket.

FIG. 4 is a side elevational view of an embodiment of the lug nut bracket similar to that of FIG. 3, showing lug nuts for securing the lug nut bracket of FIG. 3 to a vehicle axle or tire.

FIG. 5 is a top elevational view of an embodiment of a lug nut bracket having a central aperture for receiving a locking arm of the top faceplate, and is usable for axles having an even number of lug nuts so that the central aperture is centered on the wheel axle.

FIG. 6 is another embodiment of a lug nut bracket which is asymmetrical and has a central aperture for receiving a locking arm of the top faceplate, and is usable for axles having an odd number of lug nuts so that the central aperture is centered on the wheel axle.

FIG. 7 is a further embodiment of a lug nut bracket having a central aperture for receiving a locking arm of the top faceplate, and is usable for axles having an odd number of lug nuts so that the central aperture is centered on the wheel axle.

FIG. 8 is an embodiment of a decorative wheel cover or accessory, which can form part of the faceplate or can overly the faceplate.

FIG. 9 is an elevational view of the lock arm of FIG. 2.

### DETAILED DESCRIPTION OF THE INVENTION

This invention is directed to an anti-theft device 100 constituting a wheel lock for preventing illicit access to a wheel's hub area and more particularly to the wheel lug nuts. The anti-theft device 100 of the present invention is described as follows.

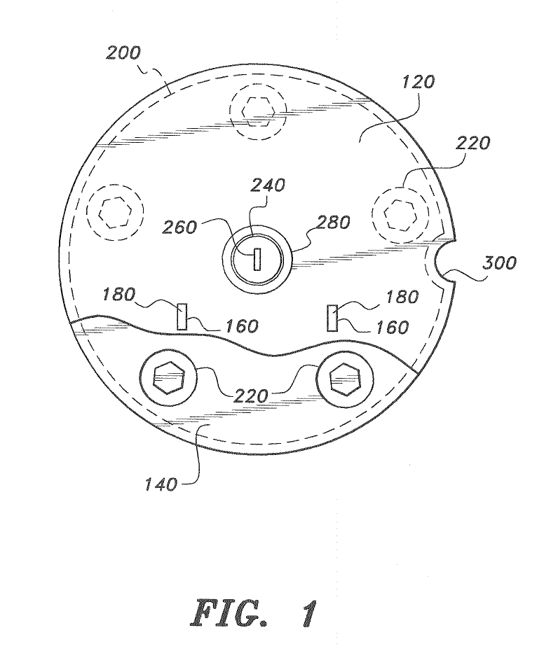

FIG. 1 is front elevational view of an anti-theft device 100, showing a top faceplate 120 overlying a lug nut bracket 140. The top faceplate 120 is coextensive in outline with the underlying lug nut bracket 140 but is partially broken away in FIG. 1 to reveal the underlying lug nuts 220 and a portion of the lug nut bracket 140.

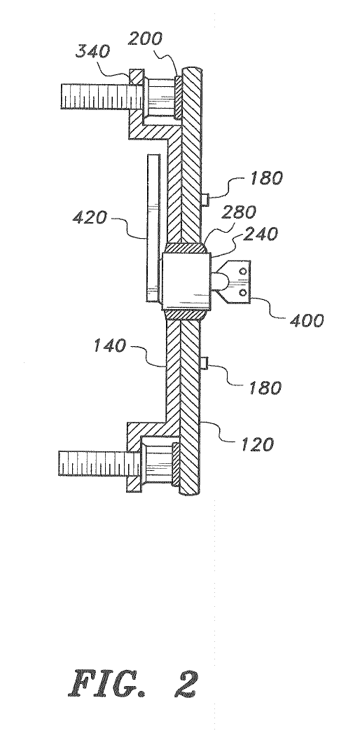

In FIG. 1, the top faceplate 120 is detachably secured to the lug nut bracket 140, described further hereunder in FIG. 2. In FIG. 1, the top faceplate 120 is secured to the lug nut bracket 140. The top faceplate 120 carries a conventional cylinder lock 240 having a keyhole 220. The cylinder lock 240 is key operated, and with a correct key inserted it can be turned to permit removal of the top faceplate 120 from the underlying lug nut bracket 140. The top faceplate 120 overlies five lug nuts in FIG. 1, and has two apertures 160. Male guides 180 of the lug nut bracket 140 extend through respective ones of the two apertures 160 in the top faceplate 120 so as to fix the top faceplate 120 against rotation and against translational movement relative to the lug nut bracket 140.

In FIG. 1, a secureguard portion 280 is shown as extending around the periphery of the cylinder lock 240 to protect the cylinder lock 240 against damage or removal. The secureguard portion 280 can be, for example, a band or cylindrical portion formed of tempered or hardened steel or other protective material known in the lock arts.

The lug nut bracket 140 is secured to the axle of a vehicle by the lug nuts 220. It is known in the vehicle arts to secure items to vehicle axles in this manner, for example decorative hub caps and wheel rims are secured in this manner. The top faceplate 120 overlies the lug nuts 220 very closely so as to prevent direct access to the lug nuts 220, and in order to operate the lug nuts 220 the top faceplate 120 must be removed. In FIG. 1, removal of the top faceplate 120 is effected by operation of a key in the cylinder lock 240, which moves a lock arm 420 (shown in FIG. 2).

The top faceplate 120 and the lug nut bracket 140 are preferably composed of strong metal material, such as steel or any strong metal alloys resistant to breakage or deformation. A secure O-ring 200 is shown in dashed outline in FIG. 1 and can for example be composed of rubber, plastic, metal, or plastic composite material. The secure O-ring 200 enhances the tightness of the connection between the top faceplate 120 with the tops of the lug nuts 220 so as to prevent insertion of a prying tool between the lug nuts 220 and the top faceplate 120.

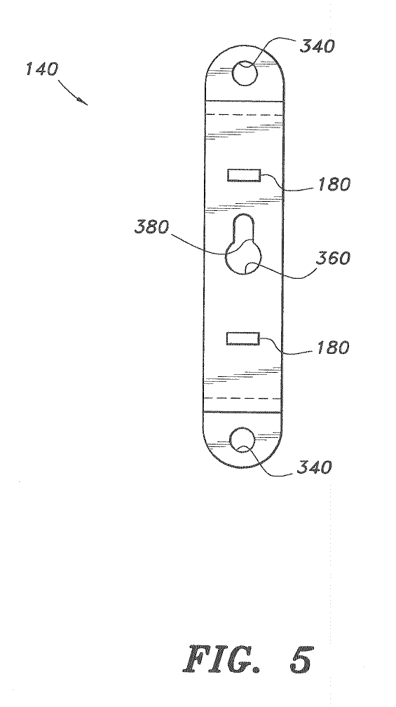

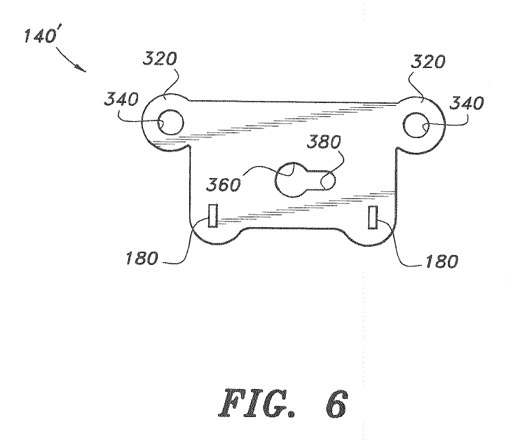

FIG. 2 is a schematic side sectional view taken along a centerline of the anti-theft device 100 of FIG. 1, the section schematically showing in elevation two of the lug nuts 220 securing the lug nut bracket 140 (the lug nuts 220 being offset from the centerline, and also showing a lock arm 420 securing the lug nut bracket 140 between the lock arm 420 and the bottom side of the top faceplate 120. A key 400 is schematically shown in FIG. 2 for turning the cylinder lock 240. Since the lock arm 420 is secured for rotation with the cylinder lock 240, rotation of the cylinder lock 240 causes rotation of the lock arm 420 to a position where it can pass through an aperture (shown in FIGS. 5 and 6 described hereunder) in the lug nut bracket 140. The guides 180 are shown in profile in FIG. 2. While two guides 180 are shown in FIG. 1, a greater number of guides 180 can be provided at arbitrary locations on the lug nut bracket 140. Also, a single guide 180 can be provided instead of two such guides 180.

In FIG. 2, the secure O-ring 200 is shown disposed between the heads of the lug nuts 220 and the bottom side of the top faceplate 120.

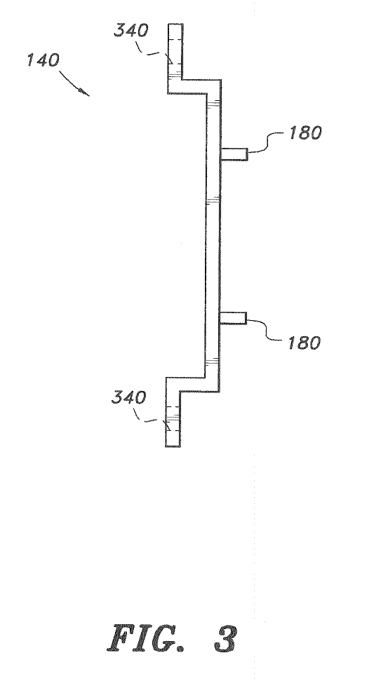

FIG. 3 is a side elevational view of an embodiment of the lug nut bracket 140, showing a pair of the male guides 180 projecting from a surface of the lug nut bracket 140. A pair of apertures 340 are shown in dashed outline in FIG. 3 to permit passage of the lug nuts 220 therethrough.

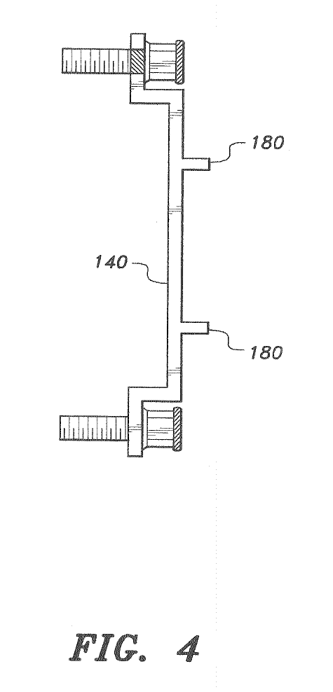

FIG. 4 is a side elevational view of an embodiment of the lug nut bracket similar to that of FIG. 3, showing the lug nuts 220 passing through the apertures 340 (shown in FIG. 3) for securing the lug nut bracket 140 to a vehicle axle.

FIG. 5 is a top elevational view of an embodiment of the lug nut bracket 140 having a central aperture 360 having an extended aperture portion 380 for receiving the locking arm 420 of the top faceplate 120, and is especially usable for axles having an even number of lug nuts 220 so that the central aperture 360 is centered on the wheel axle. Alternatively, the lug nut bracket 140 of FIG. 5 can be used with an odd number of lug nuts 220, in which case it will not be centered on the wheel axle and therefore the top faceplate 120 must have an eccentric shape so as to cover all of the lug nuts 220 securely. Such variations would be well understood by anyone having skill in the vehicle hub cap arts, and all such variations are contemplated as being within the scope of the present invention.

FIG. 6 is another embodiment of a lug nut bracket 140′ which is asymmetrical and has a central aperture 360 for receiving the lock arm 420 of the top faceplate 120, and is usable for axles having an odd number of lug nuts 220 so that the central aperture 360 is centered on the wheel axle.

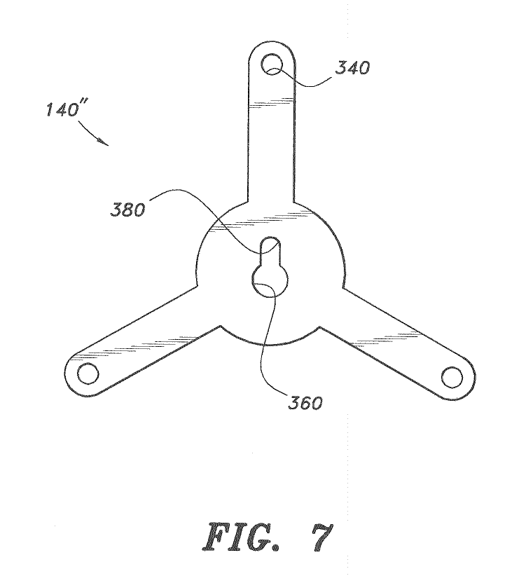

FIG. 7 is a further embodiment of a lug nut bracket 140″ having three arms and a central aperture 360 for receiving the lock arm 420 of the top faceplate 120, and is usable for axles having an odd number of lug nuts 220 so that the central aperture 360 is centered on the wheel axle. Other variations are possible within the spirit of FIGS. 5-7; all such variations would be well understood by anyone having skill in the vehicle hub cap arts, and all such variations are contemplated as being within the scope of the present invention.

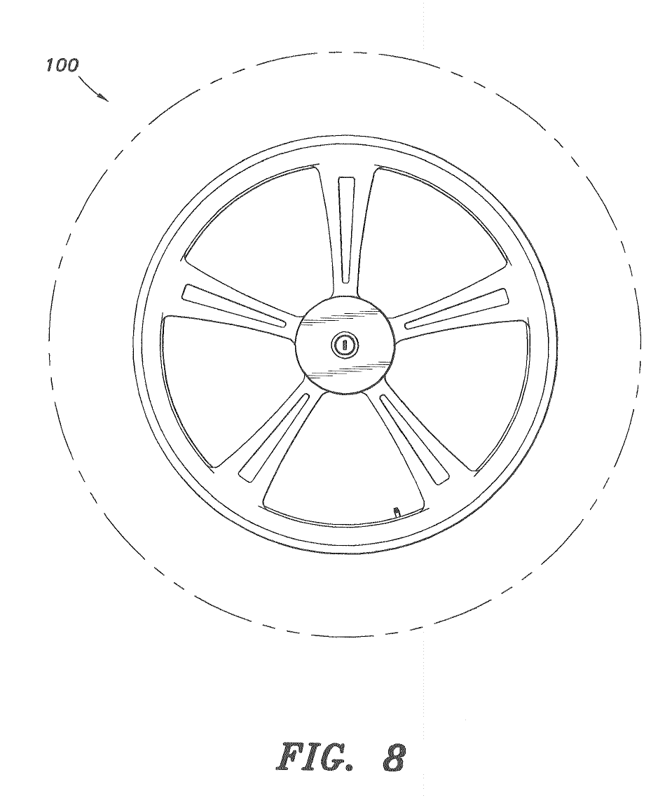

FIG. 8 is an embodiment of a decorative wheel cover or accessory for an alternative embodiment of the anti-theft device 100′, and which can form part of the top faceplate 120 or can overly the top faceplate 120.

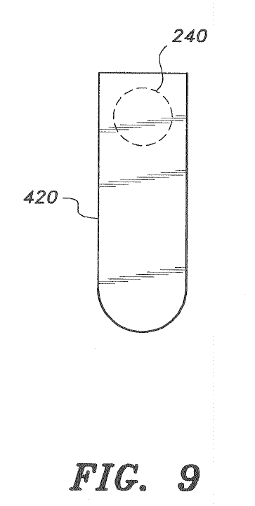

FIG. 9 is an elevational view of the lock arm 420 of FIG. 2. The cylinder lock 240 is shown in dashed outline in FIG. 9. It will be understood that other shapes can be used for the lock arm 420, including a double-arm shape, a star shape centered on the cylinder lock 240, or any other shape adequate to secure the top faceplate 120 to the lug nut bracket 140 when the cylinder lock 240 is rotated. In each case, the shape of the aperture 360 will conform to the shape of the lock arm 420 in order to permit passage of the lock arm 420 therethrough.

In addition to the foregoing, the present invention also contemplates addition of a cover for the cylinder lock 240 to hide it. Also, other decorative or ornamental items can be added on top of the top faceplate 120 such as decorative hub cap covers, and such variations would be well understood by anyone having skill in the vehicle hub cap arts, and all such variations are contemplated as being within the scope of the present invention.

The invention being thus described, it will be evident that the same may be varied in many ways by a routineer in the applicable arts. Such variations are not to be regarded as a departure from the spirit and scope of the invention and all such modifications are intended to be included within the scope of the claims.

What is claimed is:

1. An anti-theft device for preventing unauthorized removal of a rim from a vehicle axle, comprising:
a top faceplate;
a lug nut bracket having at least two apertures adapted to receive lug nuts for securing the lug nut bracket to a vehicle axle;
a lockable connection means for connecting the top faceplate to the lug nut bracket;
whereby in a locked condition the top faceplate closely overlies the lug nuts of a vehicle axle to prevent access to the lug nuts thereby preventing unauthorized removal of the lug nuts.

2. The anti-theft device of claim 1, wherein the top faceplate is substantially coextensive in outline with the underlying lug nut bracket when locked thereto.

3. The anti-theft device of claim 1, wherein the lockable connection means in the top faceplate is a key operated cylinder lock.

4. The anti-theft device of claim 3, further comprising a secureguard ring surrounding the cylinder lock for protecting the cylinder lock from damage and removal.

5. The anti-theft device of claim 1, wherein the lockable connection means in the top faceplate is a key operated cylinder lock, and further comprising a lock arm connected for rotational movement of the cylinder lock.

6. The anti-theft device of claim 5, wherein the lug nut bracket has an aperture shaped for enabling passage of the lock arm therethrough in an unlocked condition of the lockable connection means and for preventing passage of the lock arm therethrough in a locked condition of the lockable connection means.

7. An anti-theft device for preventing unauthorized removal of a rim from a vehicle axle, comprising:
a top faceplate having a diameter sufficiently large to overly all of the lug nuts of a vehicle axle;
a lug nut bracket having at least two apertures adapted to receive lug nuts for securing the lug nut bracket to a vehicle axle; and wherein the lug nut bracket has an asymmetrical shape so that when connected to an axle having an odd number of lug nuts, a portion of the lug nut bracket overlies the center of the vehicle axle;
a lockable connection means for connecting the top faceplate to the lug nut bracket;
whereby in a locked condition the top faceplate closely overlies the lug nuts of a vehicle axle to prevent access to the lug nuts thereby preventing unauthorized removal of the lug nuts.

8. The anti-theft device of claim 7, wherein the top faceplate is non-coextensive in outline with the underlying lug nut bracket when locked thereto.

9. The anti-theft device of claim 7, wherein the lockable connection means in the top faceplate is a key operated cylinder lock.

10. The anti-theft device of claim 9, further comprising a secureguard ring surrounding the cylinder lock for protecting the cylinder lock from damage and removal.

11. The anti-theft device of claim 7, wherein the lockable connection means in the top faceplate is a key operated cylinder lock, and further comprising a lock arm connected for rotational movement of the cylinder lock.

12. The anti-theft device of claim 11, wherein the lug nut bracket has an aperture shaped for enabling passage of the lock arm therethrough in an unlocked condition of the lockable connection means and for preventing passage of the lock arm therethrough in a locked condition of the lockable connection means.

13. An anti-theft device for preventing unauthorized removal of a rim from a vehicle axle, comprising:
a top faceplate having a secure O-ring on a periphery thereof for facing engagement with lug nuts of a vehicle axle;
a lug nut bracket having at least two apertures adapted to receive lug nuts for securing the lug nut bracket to a vehicle axle;
a lockable connection means for connecting the top faceplate to the lug nut bracket;
whereby in a locked condition the top faceplate closely overlies the lug nuts of a vehicle axle to prevent access to the lug nuts thereby preventing unauthorized removal of the lug nuts.
